(19) United States
(12) Patent Application Publication
(10) Pub. No.: US 2009/0306841 A1
(43) Pub. Date: Dec. 10, 2009

(54) VEHICLE AND METHOD FOR FAILURE DIAGNOSIS OF VEHICLE

(75) Inventors: Koji Miwa, Susono-shi (JP); Yoshiaki Atsumi, Susono-shi (JP); Koichi Osawa, Susono-shi (JP); Shigeki Kinomura, Suntou-gun (JP)

Correspondence Address: OLIFF & BERRIDGE, PLC, P.O. BOX 320850, ALEXANDRIA, VA, 22320-4850, US

(73) Assignee: TOYOTA JIDOSHA KABUSHIKI KAISHA, TOYOTA-SHI (JP)

(21) Appl. No.: 12/312,930

(22) PCT Filed: May 15, 2008
(86) PCT No.: PCT/JP2008/059412

§ 371 Date: Jun. 1, 2009

(30) Foreign Application Priority Data
May 18, 2007 (JP) 2007-133257

(51) Int. Cl. B60W 20/00; G06F 7/00

(52) U.S. Cl. 701/22; 701/29; 903/951

(57) ABSTRACT

A vehicle (100) includes: a battery (B1, B2); a motor generator (MG2) driven by electric power stored in the battery (B1); a coupling unit (41) for electrically coupling the battery (B1, B2) to an external commercial power supply (55); and a controller (60) for operating an electrical component (43) and performing failure diagnosis of the electrical component (43) in a case where the vehicle and the external power supply can be electrically coupled by operating the coupling unit (41). As a result, there can be provided a vehicle that can be charged from outside and allows early detection of a failure without reducing a distance that can be traveled, and a method for failure diagnosis of the vehicle.

### TECHNICAL FIELD

The present invention relates to a vehicle and a method for failure diagnosis of the vehicle, and in particular, to a vehicle configured to be chargeable from outside, and a method for failure diagnosis of the vehicle.

### BACKGROUND ART

In recent years, a hybrid vehicle using a motor and an engine to drive wheels has received attention as an environmentally-friendly vehicle. It has also been considered that such a hybrid vehicle is configured to be chargeable from outside. With such a configuration, the vehicle is charged at home and the like, so that it is not necessary for a driver to go to a service station for refueling very often, which offers convenience to the driver. In addition, inexpensive midnight electric power and the like can be used, which is considered to be also beneficial in terms of cost. Furthermore, exhaust gas from the vehicle can be reduced.

Japanese Patent Laying-Open No. 8-19114 discloses a hybrid electric vehicle on which a battery that can be charged by external charging means is mounted.

In a case where the hybrid vehicle is configured to be chargeable from outside, however, the main traveling mode is the EV traveling in which the vehicle travels as an electric vehicle, and the rate of operation of an engine may be extremely lowered. In such a manner of usage, an opportunity of failure diagnosis of components related to the engine is decreased and it becomes difficult to detect a failure.

Furthermore, if electric power is consumed for failure diagnosis of electrical components while the vehicle is traveling, a distance that can be traveled in the EV traveling mode is affected.

### DISCLOSURE OF THE INVENTION

An object of the present invention is to provide a vehicle that can be charged from outside and allows early detection of a failure without reducing a distance that can be traveled, and a method for failure diagnosis of the vehicle.

In summary, the present invention is directed to a vehicle including: a power storage device; a motor driven by electric power stored in the power storage device; a coupling unit for electrically coupling the power storage device to an external power supply; and a control unit for operating an electrical component and performing failure diagnosis of the electrical component in a case where the vehicle and the external power supply can be electrically coupled by operating the coupling unit.

Preferably, when the power storage device is being charged by using electric power supplied from outside through the coupling unit, the control unit performs the failure diagnosis in parallel with charging by using the electric power supplied from outside through the coupling unit or the electric power charged in the power storage device.

According to another aspect, the present invention is directed to a vehicle including: a power storage device; a motor driven by electric power stored in the power storage device; a coupling unit for electrically coupling the power storage device to an external power supply; and a control unit for operating an electrical component by using electric power supplied from at least any one of the power storage device and the external power supply, and performing failure diagnosis of the electrical component, in a state where the coupling unit and the external power supply are physically connected.

Preferably, the control unit determines a state of charge of the power storage device, and upon determining that the state of charge is not less than a prescribed value, the control unit performs failure diagnosis of the electrical component.

Preferably, the control unit performs failure diagnosis of the electrical component when a charging cost in a case where the power storage device is charged by the external power supply is lower than a reference value.

Preferably, the coupling unit includes a connector for electrically connecting the external power supply and the vehicle. The vehicle further includes a transmitting unit for transmitting information about the failure diagnosis to the outside of the vehicle through a cable connected between the connector and the external power supply.

Preferably, the coupling unit includes a connector for electrically connecting the external power supply and the vehicle. The vehicle further includes a receiving unit for receiving a control program of the electrical component from outside of the vehicle through a cable connected between the connector and the external power supply.

Preferably, the vehicle further includes an internal combustion engine. The electrical component is a component related to at least one of intake and discharge of air in the internal combustion engine.

According to still another aspect, the present invention is directed to a method for failure diagnosis of a vehicle having a power storage device, a motor driven by electric power stored in the power storage device, and a coupling unit for electrically coupling the power storage device and an external power supply, including the steps of: determining that the vehicle and the external power supply can be electrically coupled by operating the coupling unit; and operating an electrical component and performing failure diagnosis of the electrical component in a case where the vehicle and the external power supply can be electrically coupled.

Preferably, the method for failure diagnosis of the vehicle further includes the step of: charging the power storage device by using electric power supplied from outside through the coupling unit. In the step of performing failure diagnosis, the failure diagnosis is performed in parallel with charging by using the electric power supplied from outside through the coupling unit or the electric power charged. in the power storage device.

According to the present invention, early detection of a failure is allowed without reducing a distance that can be traveled.

### BRIEF DESCRIPTION OF THE DRAWINGS

FIG. 1 is a schematic block diagram of a vehicle 100 according to the present embodiment.

FIG. 2 is a circuit diagram showing an equivalent circuit of inverters 20 and 30 as well as motor generators MG1 and MG2 shown in FIG. 1.

FIG. 3 shows a general configuration in a case where a computer is used as a controller 60.

FIG. 4 is a flowchart showing a control structure of a program relating to the determination as to the start of charging by controller 60 shown in FIG. 1.

FIG. 5 is a schematic diagram for illustrating the periphery of an engine 4 of vehicle 100.

FIG. 6 is a flowchart for illustrating control for execution of failure diagnosis.

FIG. 7 is a flowchart for illustrating control in a second embodiment.

FIG. 8 is a diagram for schematically illustrating a third embodiment of the present invention.

FIG. 9 is a block diagram showing a configuration of a vehicle and a charging device in more detail.

FIG. 10 is a flowchart for illustrating control relating to charging and failure diagnosis performed in a vehicle 100A.

### BEST MODES FOR CARRYING OUT THE INVENTION

The embodiments of the present invention will be described hereinafter in detail with reference to the drawings. The same or corresponding components are designated by the same reference characters in the drawings, and description thereof will not be repeated.

### First Embodiment

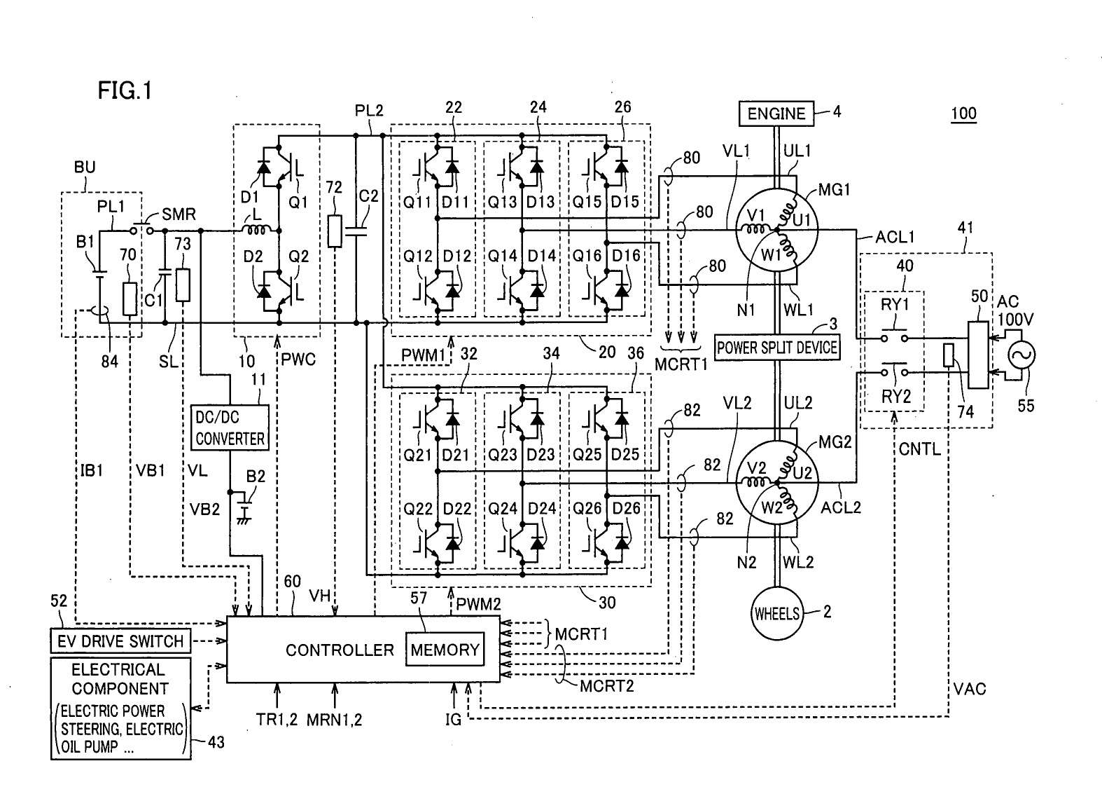

FIG. 1 is a schematic block diagram of a vehicle 100 according to the present embodiment.

Referring to FIG. 1, this vehicle 100 includes a battery unit BU, a boost converter 10, inverters 20 and 30, power supply lines PL1 and PL2, a ground line SL, U-phase lines UL1 and UL2, V-phase lines VL1 and VL2, W-phase lines WL1 and WL2, motor generators MG1 and MG2, an engine 4, a power split device 3, and wheels 2.

This vehicle 100 is a hybrid vehicle using the motor and the engine to drive the wheels.

Power split device 3 is a device that is coupled to engine 4 and motor generators MG1 and MG2 to distribute motive power therebetween. For example, a planetary gear mechanism having three rotation shafts of a sun gear, a planetary carrier and a ring gear can be used as the power split device. These three rotation shafts are connected to rotation shafts of engine 4 and motor generators MG1 and MG2, respectively. For example, engine 4 and motor generators MG1 and MG2 can be mechanically connected to power split device 3 by allowing a crankshaft of engine 4 to extend through the center of a hollow space in a rotor of motor generator MG1.

It is noted that the rotation shaft of motor generator MG2 is coupled to wheels 2 through a reduction gear and a differential gear that are not shown. A decelerator for the rotation shaft of motor generator MG2 may further be incorporated into power split device 3.

Motor generator MG1 is incorporated into the hybrid vehicle as a motor generator that operates as a generator driven by the engine and operates as a motor that may start up the engine. Motor generator MG2 is incorporated into the hybrid vehicle as a motor that drives drive wheels of the hybrid vehicle.

Motor generators MG1 and MG2 are, for example, three-phase AC synchronous motors. Motor generator MG1 includes, as a stator coil, a three-phase coil formed of a U-phase coil U1, a V-phase coil V1 and a W-phase coil W1. Motor generator MG2 includes, as a stator coil, a three-phase coil formed of a U-phase coil U2, a V-phase coil V2 and a W-phase coil W2.

Motor generator MG1 generates a three-phase AC voltage by using an output of the engine, and outputs the generated three-phase AC voltage to inverter 20. Furthermore, motor generator MG1 generates driving force by a three-phase AC voltage received from inverter 20, and starts up the engine.

Motor generator MG2 generates driving torque for the vehicle by a three-phase AC voltage received from inverter 30. Furthermore, during regenerative braking of the vehicle, motor generator MG2 generates a three-phase AC voltage and outputs the generated three-phase AC voltage to inverter 30.

Battery unit BU includes a battery B1 serving as a power storage device having a negative electrode connected to ground line SL, a voltage sensor 70 for measuring a voltage VB1 of battery B1, and a current sensor 84 for measuring a current B1 of battery B1. A vehicle load includes motor generators MG1 and MG2, inverters 20 and 30, and boost converter 10 supplying a boosted voltage to inverters 20 and 30.

A secondary battery, such as a nickel hydride battery, a lithium ion battery and a lead acid battery can be used as battery B1, for example. Furthermore, instead of battery B1, an electric double layer capacitor having a large capacitance can also be used.

Battery unit BU outputs, to boost converter 10, a DC voltage output from battery B1. Furthermore, battery B1 within battery unit BU is charged by a DC voltage output from boost converter 10.

Boost converter 10 includes a reactor L, npn-type transistors Q1 and Q2, and diodes D1 and D2. Reactor L has one end connected to power supply line PL1, and the other end connected to a connection point of npn-type transistors Q1 and Q2. Npn-type transistors Q1 and Q2 are serially connected between power supply line PL2 and ground line SL, and receive at bases thereof a signal PWC from controller 60. Diodes D1 and D2 are connected between the collectors and the emitters of npn-type transistors Q1 and Q2, respectively, such that a current flows from the emitter side to the collector side.

It is noted that an IGBT (Insulated Gate Bipolar Transistor), for example, can be used as the above-described npn-type transistors and npn-type transistors that will be described in the following specification. Furthermore, instead of the npn-type transistors, an electric power switching element such as a power MOSFET (Metal Oxide Semiconductor Field-Effect Transistor) can be used.

Inverter 20 includes a U-phase arm 22, a V-phase arm 24 and a W-phase arm 26. U-phase arm 22, V-phase arm 24 and W-phase arm 26 are connected in parallel between power supply line PL2 and ground line SL.

U-phase arm 22 includes npn-type transistors Q11 and Q12 connected in series. V-phase arm 24 includes npn-type transistors Q13 and Q14 connected in series. W-phase arm 26 includes npn-type transistors Q15 and Q16 connected in series. Diodes D11 to D16 for passing a current from the emitter side to the collector side are connected between the collectors and the emitters of npn-type transistors Q11 to Q16, respectively. A connection point of the npn-type transistors in each phase arm is connected to a coil end different from a neutral point N1 of the coil of each phase of motor generator MG1, through U-phase line UL1, V-phase line VL1 or W-phase line WL1.

Inverter 30 includes a U-phase arm 32, a V-phase arm 34 and a W-phase arm 36. U-phase arm 32, V-phase arm 34 and W-phase arm 36 are connected in parallel between power supply line PL2 and ground line SL.

U-phase arm 32 includes npn-type transistors Q21 and Q22 connected in series. V-phase arm 34 includes npn-type transistors Q23 and Q24 connected in series. W-phase arm 36 includes npn-type transistors Q25 and Q26 connected in series. Diodes D21 to D26 for passing a current from the emitter side to the collector side are connected between the collectors and the emitters of npn-type transistors Q21 to Q26, respectively. In inverter 30, a connection point of the npn-type transistors in each phase arm is also connected to a coil end different from a neutral point N2 of the coil of each phase of motor generator MG2, through U-phase line UL2, V-phase line VL2 or W-phase line WL2.

Vehicle 100 further includes capacitors C1 and C2, controller 60, AC lines ACL1 and ACL2, voltage sensors 72 and 73, current sensors 80 and 82, and a coupling unit 41 for coupling the vehicle to an external commercial power supply 55.

Capacitor C1 is connected between power supply line PL1 and ground line SL, and reduces an effect on battery B1 and boost converter 10 due to voltage fluctuations. A voltage VL between power supply line PL1 and ground line SL is measured by voltage sensor 73.

Capacitor C2 is connected between power supply line PL2 and ground line SL, and reduces an effect on inverters 20, 30 and boost converter 10 due to voltage fluctuations. A voltage VH between power supply line PL2 and ground line SL is measured by voltage sensor 72.

Boost converter 10 boosts a DC voltage supplied from battery unit BU through power supply line PL1, and outputs the boosted voltage to power supply line PL2. More specifically, based on signal PWC from controller 60, boost converter 10 passes a current in accordance with the switching operation of npn-type transistor Q2. The current causes reactor L to store magnetic field energy. The boosting operation is performed by passing a current through diode DI to power supply line PL2 in synchronization with the timing when npn-type transistor Q2 is turned off and releasing the stored energy.

Furthermore, based on signal PWC from controller 60, boost converter 10 steps down a DC voltage received from any one of or both of inverters 20 and 30 through power supply line PL2 to a voltage level of battery unit BU, and the battery within battery unit BU is charged.

Based on a signal PWM1 from controller 60, inverter 20 converts a DC voltage supplied from power supply line PL2 to a three-phase AC voltage, and drives motor generator MG1.

As a result, motor generator MG1 is driven so as to generate torque specified by a torque command value TRI. Furthermore, inverter 20 converts, to a DC voltage, the three-phase AC voltage generated by motor generator MG1 by receiving an output from the engine, based on signal PWMI from controller 60, and outputs the converted DC voltage to power supply line PL2.

Based on a signal PWM2 from controller 60, inverter 30 converts a DC voltage supplied from power supply line PL2 to a three-phase AC voltage; and drives motor generator MG2.

As a result, motor generator MG2 is driven so as to generate torque specified by a torque command value TR2. Furthermore, during regenerative braking of the hybrid vehicle having vehicle 100 mounted thereon, inverter 30 converts, to a DC voltage, the three-phase AC voltage generated by motor generator MG2 by receiving a rotational force from a drive shaft, based on signal PWM2 from controller 60, and outputs the converted DC voltage to power supply line PL2.

It is noted that the regenerative braking herein includes braking with regenerative electric power generation that is caused when the driver driving the hybrid vehicle operates a foot brake, and deceleration of the vehicle (or discontinuation of acceleration thereof) with regenerative electric power generation that is caused by releasing the accelerator pedal, not operating the foot brake, during traveling.

Coupling unit 41 for coupling the vehicle to external commercial power supply 55 includes a relay circuit 40, a connector 50 and a voltage sensor 74.

Relay circuit 40 includes relays RY1 and RY2. Although a mechanical contact relay, for example, can be used as relays RY1 and RY2, a semiconductor relay may be used. Relay RY1 is provided between AC line ACL1 and connector 50, and is turned on/off in accordance with a control signal CNTL from controller 60. Relay RY2 is provided between AC line ACL2 and connector 50, and is turned on/off in accordance with control signal CNTL from controller 60.

This relay circuit 40 connects/disconnects AC lines ACL1, ACL2 and connector 50 in accordance with control signal CNTL from controller 60. In other words, upon receiving control signal CNTL having an H (logical high) level from controller 60, relay circuit 40 electrically connects AC lines ACL1 and ACL2 to connector 50. Upon receiving control signal CNTL having an L (logical low) level from controller 60, relay circuit 40 electrically disconnects AC lines ACL1 and ACL2 from connector 50.

Connector 50 is a terminal through which an AC voltage is input from external commercial power supply 55 to between neutral points N1 and N2 of motor generators MG1 and MG2. As this AC voltage, AC100V, for example, can be input through a home-use commercial electric power line. The voltage input to connector 50 is measured by voltage sensor 74 and a measurement value is transmitted to controller 60.

It is noted that coupling unit 41 for coupling the vehicle to external commercial power supply 55 may receive and supply electric power in a non-contact manner. In this case, a coil and the like for generating an electromotive force by electromagnetic induction, a microwave and the like are provided instead of relay circuit 40 and connector 50.

Voltage sensor 70 detects battery voltage VB1 of battery B1, and outputs detected battery voltage VB1 to controller 60. Voltage sensor 73 detects a voltage across capacitor C1, that is, input voltage VL of boost converter 10, and outputs detected voltage VL to controller 60. Voltage sensor 72 detects a voltage across capacitor C2, that is, output voltage VH of boost converter 10 (corresponding to an input voltage of inverters 20 and 30, the same applies in the following), and outputs detected voltage VH to controller 60.

Current sensor 80 detects a motor current MCRT1 flowing through motor generator MG1, and outputs detected motor current MCRT 1 to controller 60. Current sensor 82 detects a motor current MCRT2 flowing through motor generator MG2, and outputs detected motor current MCRT2 to controller 60.

Controller 60 generates signal PWC for driving boost converter 10, based on torque command values TR1 and TR2 and motor rotation speeds MRN1 and MRN2 of motor generators MG1 and MG2 output from an ECU (Electronic Control Unit) that is provided outside, voltage VL from voltage sensor 73, and voltage VH from voltage sensor 72, and outputs generated signal PWC to boost converter 10.

Furthermore, controller 60 generates signal PWMI for driving motor generator MG1, based on voltage VH as well as motor current MCRT1 and torque command value TR1 of motor generator MG1, and outputs generated signal PWMI to inverter 20. In addition, controller 60 generates signal PWM2 for driving motor generator MG2, based on voltage VH as well as motor current MCRT2 and torque command value TR2 of motor generator MG2, and outputs generated signal PWM2 to inverter 30.

Here, controller 60 generates signals PWM1 and PWM2 for controlling inverters 20 and 30 such that battery B1 is charged by the AC voltage supplied from the commercial power supply to between neutral points N1 and N2 of motor generators MG1 and MG2, based on a signal IG from an ignition switch (or an ignition key) and a state of charge SOC of battery B1.

In addition, controller 60 determines whether or not battery B1 can be charged from outside, based on state of charge SOC of battery B1. When determining that battery B1 can be charged, controller 60 outputs control signal CNTL having the H level to relay circuit 40. On the other hand, when determining that battery B1 is substantially fully charged and cannot be charged, controller 60 outputs control signal CNTL having the L level to relay circuit 40. In a case where signal IG indicates a stop state. controller 60 stops inverters 20 and 30.

Vehicle 100 further includes an EV drive switch 52. EV drive switch 52 is a switch for setting the drive mode to the EV drive mode. In the EV drive mode, vehicle 100 can travel by using only the motor and the number of times that the engine is brought into operation is reduced in order to reduce noise in a heavily built-up residential area at midnight and early in the morning and to reduce exhaust gas in an indoor parking lot and a garage.

This EV drive mode is automatically cleared when EV drive switch 52 is set to the off state, when the state of charge of the battery is not more than a defined value, when the vehicle speed is not less than a prescribed speed, or when the accelerator opening degree is not less than a defined value.

In a case of the vehicle that can be charged from outside, the driver sets EV drive switch 52 to the on state when the driver desires to assign higher priority to the use of the charged electric power than the use of the fuel as an energy source for traveling. In other words, in a case where it is desirable to actively use the electric power that has been charged from external commercial power supply 55, the operation mode of the vehicle may only be switched from the normal HV mode to the EV drive mode by EV drive switch 52.

Vehicle 100 further includes a touch display that displays a condition of the vehicle and also functions as an input device for a car navigation system and the like.

Furthermore, a memory 57 that can read and write data is incorporated into controller 60. It is noted that controller 60 may be implemented by a plurality of computers such as an electric power steering computer, a hybrid control computer and a parking assist computer.

[Description of Charging from Outside of Vehicle]

Next, a method for generating a DC charging voltage from an AC voltage VAC of commercial power supply 55 in vehicle 100 will be described.

In a case of charging from outside of the vehicle, controller 60 turns npn-type transistors Q11 to Q16 (or Q21 to Q26) on/off such that an alternating current having the same phase flows through U-phase arm 22 (or 32), V-phase arm 24 (or 34) and W-phase arm 26 (or 36) of inverter 20 (or 30).

In a case where the alternating current having the same phase flows through the coil of each of U-, V- and W-phases, rotation torque is not generated at motor generators MG1 and MG2. Inverters 20 and 30 are cooperatively controlled, so that AC voltage VAC is converted to the DC charging voltage.

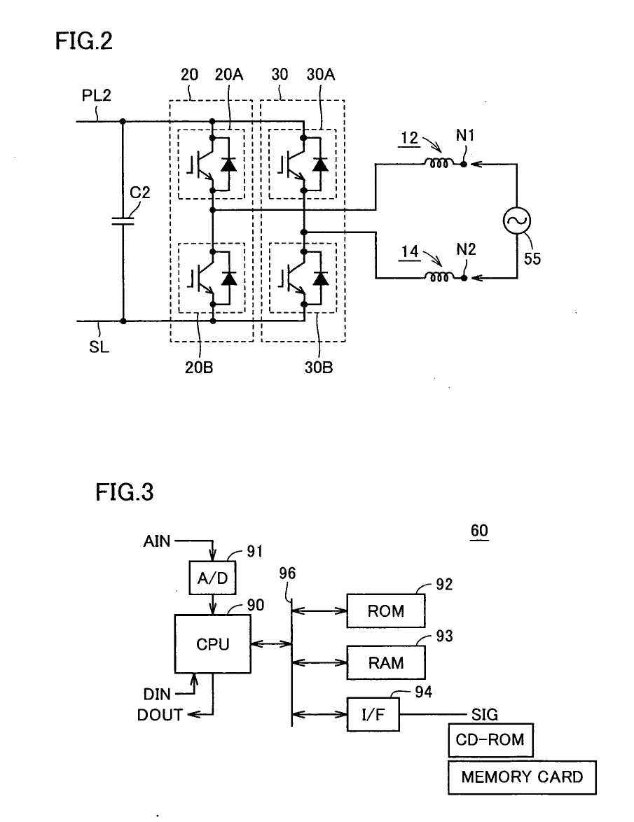

FIG. 2 is a circuit diagram showing an equivalent circuit of inverters 20 and 30 as well as motor generators MG1 and MG2 shown in FIG. 1.

In FIG. 2, npn-type transistors Q11, Q13 and Q15 of inverter 20 are collectively represented as an upper arm 20A, and npn-type transistors Q12, Q14 and Q16 of inverter 20 are collectively represented as a lower arm 20B. Similarly, npn-type transistors Q21, Q23 and Q25 of inverter 30 are collectively represented as an upper arm 30A, and npn-type transistors Q22, Q24 and Q26 of inverter 30 are collectively represented as a lower arm 30B.

As shown in FIG. 2, this equivalent circuit can be regarded as a single-phase PWM converter that uses, as an input, single-phase commercial power supply 55 electrically connected to neutral points N 1 and N2 with relay circuit 40 and connector 50 in FIG. 1 interposed therebetween. By controlling switching of inverters 20 and 30 to operate as the phase arm of the single-phase PWM converter, respectively, single-phase AC electric power from commercial power supply 55 can be converted to DC electric power and supplied to power supply line PL2.

Controller 60 described in above FIGS. 1 and 2 can be implemented by hardware. Controller 60, however, can also be implemented by software by using a computer.

FIG. 3 shows a general configuration in a case where a computer is used as controller 60.

Referring to FIG. 3, the computer serving as controller 60 includes a CPU 90, an A/D converter 91, a ROM 92, a RAM 93, and an interface unit 94.

A/D converter 91 converts an analog signal AIN such as outputs of various types of sensors to a digital signal, and outputs the converted digital signal to CPU 90. Furthermore, CPU 90 is connected to ROM 92, RAM 93 and interface unit 94 via a bus 96 such as a data bus and an address bus, and receives and transmits data.

ROM 92 has data such as, for example, a program executed by CPU 90 and a referred map stored therein. RAM 93 is, for example, a work area in a case where CPU 90 performs data processing, and has various types of variables temporarily stored therein.

Interface unit 94, for example, communicates with other ECUs, inputs rewritten data in a case where an electrically rewritable flash memory or the like is used as ROM 92, and reads a data signal SIG from a computer readable storage medium such as a memory card and a CD-ROM.

It is noted that CPU 90 receives and transmits a data input signal DIN and a data output signal DOUT from/to an input/output port.

Controller 60 is not limited to such a configuration, but may be implemented to include a plurality of CPUs.

[Control During Charging]

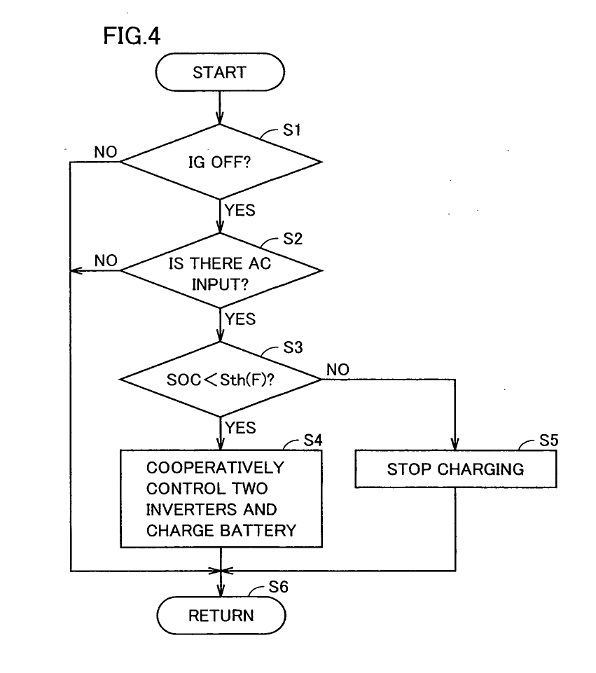

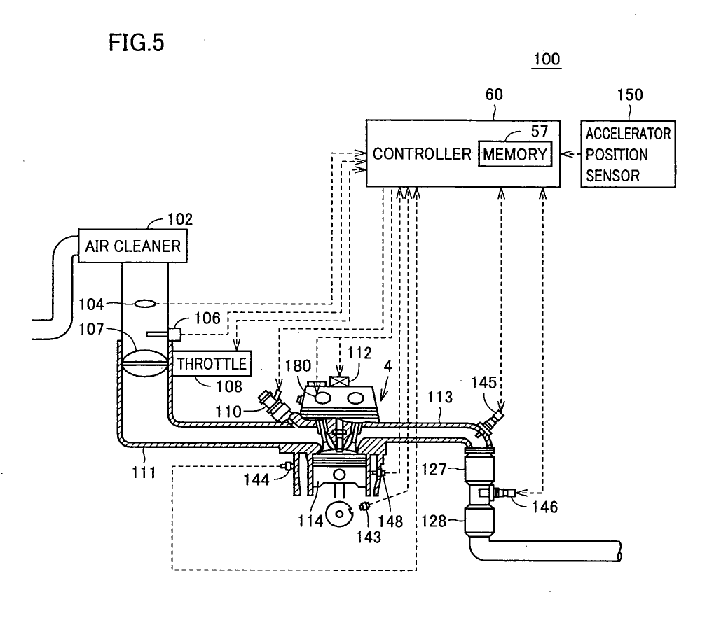

FIG. 4 is a flowchart showing a control structure of a program relating to the determination as to the start of charging by controller 60 shown in FIG. 1. It is noted that the process in this flowchart is called for execution from a main routine at regular time intervals or whenever a prescribed condition is established.

Referring to FIG. 4, controller 60 determines whether or not the ignition key is set to the off position, based on signal IG from the ignition key (step S1). Upon determining that the ignition key is not set to the off position (NO in step S1), controller 60 determines that it is not appropriate to connect commercial power supply 55 to connector 50 for charging of battery B1. The process proceeds to step S6, and the control is returned to the main routine.

Upon determining in step S1 that the ignition key is set to the off position (YES in step S1), controller 60 determines whether or not a plug for charging is connected and AC electric power from commercial power supply 55 is input to connector 50, based on voltage VAC from voltage sensor 74 (step S2). When voltage VAC is not observed, controller 60 determines that the AC electric power is not input to connector 50 (NO in step S2). The process proceeds to step S6, and the control is returned to the main routine.

On the other hand, when voltage VAC is detected, controller 60 determines that the AC electric power from commercial power supply 55 is input to connector 50 (YES in step S2). Then, controller 60 determines whether or not SOC of battery B1 is smaller than a threshold value Sth(F) (step S3). Here, threshold value Sth(F) is a determination value used to determine whether or not SOC of battery B1 is sufficient.

Upon determining that SOC of battery B1 is smaller than threshold value Sth(F) (YES in step S3), controller 60 renders an input permission signal EN to be output to relay circuit 40 active. Controller 60 controls switching of two inverters 20 and 30 that are each regarded as the phase arm of the single-phase PWM converter while operating each phase arm of each of two inverters 20 and 30 in the same switching state, and performs charging of battery B1 (step S4). Thereafter, the process proceeds to step S6, and the control is returned to the main routine.

On the other hand, upon determining in step S3 that SOC of battery B1 is larger than or equal to threshold value Sth(F) (NO in step S3), controller 60 determines that it is not necessary to charge battery B1, and performs a charging stop processing (step S5). Specifically, controller 60 stops inverters 20 and 30, and in addition, renders input permission signal EN that is output to relay circuit 40 inactive. Thereafter, the process proceeds to step S6, and the control is returned to the main routine.

[Description of Components Related to Engine]

The hybrid vehicle that can be charged from outside has been described above. In the hybrid vehicle that can be charged from outside as described above, it is expected that the range of application of the electric vehicle traveling (EV traveling) is extended and a time required for startup of the engine is decreased. Therefore, an opportunity of failure diagnosis in which the occurrence of an abnormality is detected during operation of the engine is decreased. For example, even if a failure occurs in the components related to the engine, it may not be noticed and the components may be left in the failed state for a long time because the engine is not used. Thus, a configuration related to the operation of the engine of this hybrid vehicle will be first described.

FIG. 5 is a schematic diagram for illustrating the periphery of engine 4 of vehicle 100.

Referring to FIG. 5, engine 4 includes an intake path 111 through which intake air is introduced into a cylinder head, and an exhaust path 113 through which air is discharged from the cylinder head.

An air cleaner 102, an air flow meter 104, an intake air temperature sensor 106, and a throttle valve 107 are provided in turn from upstream of intake path 111. The opening degree of throttle valve 107 is controlled by an electronic control throttle 108. An injector 110 injecting fuel is provided near an intake valve of intake path 111.

An air/fuel ratio sensor 145, a catalytic device 127, an oxygen sensor 146, and a catalytic device 128 are arranged at exhaust path 113 in turn from the exhaust valve side. Engine 4 further includes a piston 114 moving up and down in a cylinder provided in the cylinder block, a crank position sensor 143 for detecting the rotation of the crankshaft that rotates in accordance with the up-and-down movement of piston 114, a knock sensor 144 for detecting the occurrence of knocking by detecting vibrations of the cylinder block, a water temperature sensor 148 attached to a cooling water passage of the cylinder block, and a VVT (Variable Valve Timing) mechanism 180 for fine-adjustment of the timing when the valve is opened.

Controller 60 changes an amount of intake air by controlling electronic control throttle 108 in accordance with an output of an accelerator position sensor 150, and in addition, outputs an ignition instruction to an ignition coil 112 in accordance with a crank angle obtained from crank position sensor 143, and outputs a fuel injection timing to injector 110. Furthermore, controller 60 corrects an amount of fuel injection, an amount of air and an ignition timing in accordance with outputs of intake air temperature sensor 106, knock sensor 144, air/fuel ratio sensor 145, and oxygen sensor 146.

As described above, many electrical components such as the sensors and motors are used to operate engine 4. For example, a mechanism having a motor includes electronic control throttle 108, electric VVT mechanism 180 and the like. Although not shown, a motor is also used in an electric water pump, an electric oil pump, an electric turbo charger, and the like. Even if the electrical components fail, controller 60 can detect an abnormality as long as there is an opportunity to operate engine 4. Even if there is no opportunity to operate engine 4, factors that lead to a failure, such as vibration, are provided to the vehicle as a result of EV traveling. Therefore, periodic failure diagnosis is desirable, if possible.

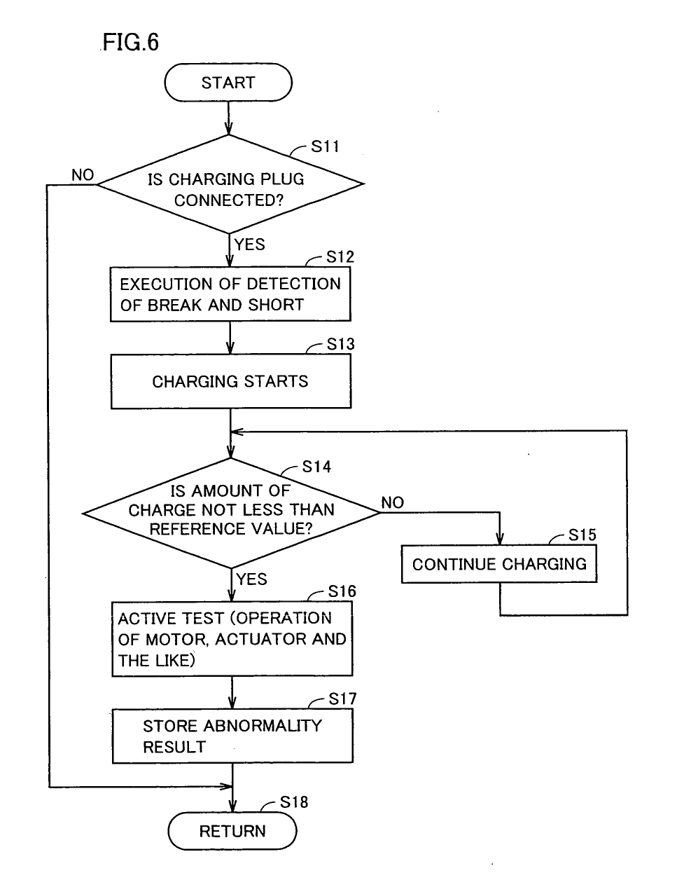

FIG. 6 is a flowchart for illustrating control for execution of failure diagnosis. It is noted that the process in this flowchart is called for execution from a main routine at regular time intervals or whenever a prescribed condition is established.

Referring to FIGS. 1 and 6, initially, when the process starts, controller 60 determines whether or not a charging plug is connected to connector 50 in step S11. Controller 60 can detect whether or not the charging plug is connected, depending on whether or not the voltage of AC 100V is detected at voltage sensor 74. It is noted that another sensor or switch for physically detecting insertion of the plug may be provided.

If the connection of the charging plug is not detected in step S11, the process proceeds to step S18, and the control is moved to the main routine.

If the connection of the charging plug is detected in step S11, the process proceeds to step S12. In step S12, detection of a break and a short is performed.

Specifically, as a result of conduction of relay circuit 40, the voltage of AC 100V from the commercial power supply is applied to neutral points N1 and N2, and inverters 20 and 30 are cooperatively operated. Voltage sensor 72 detects whether or not DC voltage VH is generated between power supply line PL2 and ground line SL, and current sensors 80 and 82 detect the direction of the current at this time, thereby confirming whether or not normal charging is possible.

In addition, it is checked whether or not a break and a short occur in signal lines of the various types of sensors that are not directly related to charging. These can be detected in a case where outputs of the sensors are outside the range that the outputs originally indicate. For example, if a value of the accelerator position sensor in FIG. 5 is outside the normal range, an abnormality of the accelerator position sensor is detected. Furthermore, if the signal line is coupled to a power supply potential, a ground potential or an intermediate potential therebetween with high resistance, a short open check of the signal line can be performed even if the sensor itself does not operate.

If normal charging is possible, the following failure diagnosis is performed by using electric power supplied from commercial power supply 55. Voltage VH converted from the commercial power supply voltage by cooperatively operating inverters 20 and 30 is used as a high-voltage power supply voltage. A voltage VB2 converted from voltage VH by DC/DC converter 11 by bringing transistor Q1, which is the upper arm of the boost converter, into conduction can be used as a low-voltage power supply voltage. Voltage VB2 is connected to an auxiliary battery B2. Voltage VB2 is used as a power supply voltage for controller 60 or a power supply voltage for a part of an electrical component 43 (for example, the motor, the sensor and the like included in electronic control throttle 108 in FIG. 5).

Therefore, if the charging plug is inserted, electric power for failure diagnosis is directly supplied from the commercial power supply, or the battery is immediately charged from the commercial power supply even if electric power for failure diagnosis is supplied from the battery. Thus, discharge of batteries B1 and B2 does not basically proceed by failure diagnosis.

Next, in step S13, a system main relay SMR is set to a conduction state, and charging starts. Then, in step S14, it is determined whether or not an amount of charge of battery B1 is not less than a reference value. There can be various methods for determining priorities assigned to failure diagnosis and charging. In the first embodiment, battery B1 is initially charged such that the amount of charge (or state of charge SOC) thereof has a value not less than the reference value, and then, an active test whose electric power consumption is large is performed.

Although there are various methods for finding the state of charge of battery B1, the state of charge may be found by a map indicating the relationship between the state of charge and an open end voltage measured periodically, for example. Furthermore, the state of charge may be found by adding an open end voltage in the initial state and an amount of charge from the initial state, for example. In addition, the state of charge may be found by combining these, that is, by periodic measurement of the open end voltage and addition of the amount of charge.

It is noted that, after charging starts in step S13, it may be checked whether or not a break and a short occur in the signal lines of the various types of sensors that are not directly related to charging. As a result, electric power of the battery is not consumed for failure diagnosis of these sensors.

In a case where the amount of charge (state of charge) of the battery is not equal to or larger than the reference value in step S14, the process proceeds to step S15. Charging continues and the determination in step S14 is again performed. If the amount of charge of the battery is not less than the reference value in step S14, the process proceeds to step S16, and the active test is performed.

It is noted that, if the reference value of the amount of charge is set to a value in a full charge state, the active test in step S16 is performed after charging is completed. If the reference value of the amount of charge is set to a value at which the vehicle can travel a certain distance, the active test in step S16 is performed in parallel with charging of the battery.

The active test in step S16 is a test in which it is necessary to operate the electrical component whose electric power consumption is relatively large, such as a motor and an actuator. Specifically, the motor of electronic control throttle 108 in FIG. 5 is operated, and it is tested, for example, whether or not a scheduled operation is detected by a throttle sensor. Other test in which the motor of electric VVT mechanism 180, the electric water pump, the electric oil pump, the electric turbo charger, or the like is operated may be performed.

If a result of the active test for failure diagnosis is revealed in step S16, the process proceeds to step S17. In step S17, the diagnosis result in steps S12 and S16 that there is an abnormality is stored in memory 57. This stored data is read and used in order to determine a type of failure at a dealer or a repair shop.

After the storage of the abnormality result in step S17 is terminated, the process proceeds to step S18, and the control is moved to the main routine.

Now, the invention according to the present embodiment will be summarized by mainly using FIG. 1 again.

Vehicle 100 includes batteries B1 and B2, motor generator MG2 driven by electric power stored in battery B1, coupling unit 41 for electrically coupling battery B1 or B2 to external commercial power supply 55, and controller 60 for operating electrical component 43 and performing failure diagnosis of electrical component 43 in a case where the vehicle and the external power supply can be electrically coupled by operating coupling unit 41.

It is noted that “operate” herein means not only that the electrical component of interest is brought to a state with the mechanical movement of the motor and the like, but also that the electrical component of interest is brought to an electrically active state without the mechanical movement, such as lighting-up of a lamp and conduction of a transistor.

Preferably, when battery B1 or B2 is being charged by using electric power supplied from outside through coupling unit 41, controller 60 performs failure diagnosis in parallel with charging by using the electric power supplied from outside through coupling unit 41 or the electric power charged in battery B1 or B2.

According to another aspect of the present invention, the vehicle includes batteries B1 and B2, motor generator MG2 driven by electric power stored in battery B1, coupling unit 41 for electrically coupling battery B1 or B2 to the external power supply, and controller 60 for operating the electrical component by using electric power supplied from at least any one of battery B1 or B2 and the external power supply, and performing failure diagnosis of the electrical component, in a state where coupling unit 41 and the external power supply are physically connected.

It is noted that “a state where coupling unit 41 and the external power supply are physically connected” herein includes, for example, a state where the external power supply and the vehicle are connected by a charging cable or the like, and a state where the charging plug is inserted into the vehicle.

Preferably, controller 60 determines the state of charge (SOC) of battery B1 or B2, and upon determining that the state of charge is not less than the prescribed value, controller 60 performs failure diagnosis of electrical component 43.

Preferably, vehicle 100 further includes engine 4. The electrical component is a component of electronic control throttle 108, electric VVT 180 or the like that relates to at least one of intake and discharge of air in engine 4.

With such a configuration, in a vehicle that can be charged from outside and in which it is desired to cover a long distance by the EV traveling, electric power stored in the battery is not decreased. Therefore, early detection of a failure is allowed without reducing a distance that can be traveled.

### Second Embodiment

In the first embodiment, the case has been described in which, when the charging plug is inserted, charging is initially performed, and then the active test is performed when the amount of charge equal to the reference amount is ensured. In a second embodiment, an example will be described in which charging. starts after the active test is performed.

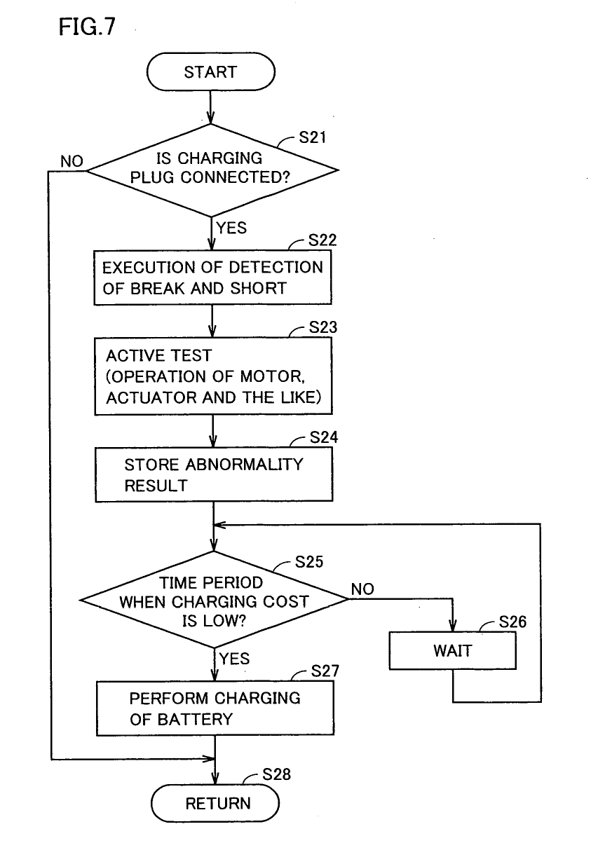

FIG. 7 is a flowchart for illustrating control in the second embodiment.

Referring to FIG. 7, checking whether or not the charging plug is connected in step S21 and execution of detection of a break and a short in step S22 are the same as those in steps S11 and S12 in FIG. 6, respectively, and therefore, description thereof will not be repeated.

After the process in step S22 is terminated, the active test is performed in step S23, unlike in FIG. 6. Specifically, the motor of electronic control throttle 108 in FIG. 5 is operated, and it is tested, for example, whether or not a scheduled operation is detected by the throttle sensor. Other test in which the motor of electric VVT mechanism 180, the electric water pump, the electric oil pump, the electric turbo charger, or the like is operated, as well as failure diagnosis of an ignition device provided in the cylinder and an evaporator for processing evaporated fuel, and the like may be performed.

If a result of the active test for failure diagnosis is revealed in step S23, the process proceeds to step S24. In step S24, the diagnosis result in steps S22 and S23 that there is an abnormality is stored in memory 57. This stored data is read and used in order to determine a type of failure at a dealer or a repair shop.

After the storage of the abnormality result in step S24 is terminated, the process proceeds to step S25, and it is determined whether or not the charging cost is low if charging is performed at this moment. Specifically, it is determined whether or not the current time belongs to the time period when the charging cost is low. It is well known that the electric power rate at midnight is cheaper than the electric power rate during the daytime. Therefore, in a case where the current time does not belong to the time period when the electric power rate at midnight is applied, the process proceeds from step S25 to step S26, and the process waits until charging starts.

When the current time enters the time period when the electric power receiving cost is low in step S25, the process proceeds to step S27, and the battery is charged from the external commercial electric power. Then, after charging of the battery is completed, the process proceeds to step S28, and the control is moved to the main routine.

In the second embodiment, controller 60 performs failure diagnosis of electrical component 43 when the charging cost in a case where battery B1 or B2 is charged from external commercial power supply 55 is lower than the reference value.

Therefore, in the second embodiment, failure diagnosis of the vehicle such as the active test can be performed without reducing the electric power of the battery. Furthermore, higher priority is assigned to the active test than charging, and charging is performed afterward. Therefore, the second embodiment is especially effective in a case where charging is performed by using midnight electric power, for example.

### Third Embodiment

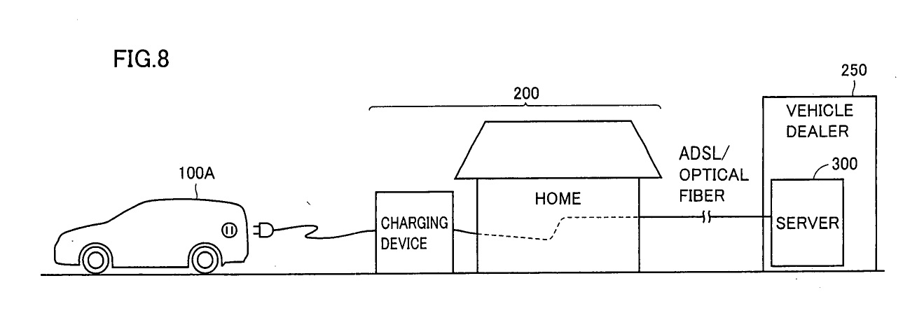

FIG. 8 is a diagram for schematically illustrating a third embodiment of the present invention.

Referring to FIG. 8, a vehicle 100A is a hybrid vehicle that has a power storage device mounted thereon and uses electric power of the power storage device for traveling. Vehicle 100A has a configuration in which the power storage device can be charged from outside.

For example, vehicle 100A returns home where it is charged. A charging device 200 and vehicle 100A are connected by the charging cable.

When the vehicle is connected by the charging cable for charging, the vehicle transmits and obtains required information. This information is used for replay, execution, interpretation, and the like on the vehicle-mounted equipment. For example, this information includes, as an example, a result of failure diagnosis, an updated program of a vehicle control ECU, data used by the vehicle control ECU, and the like. It is noted that information used in the car navigation, music data and the like, for example, may be received and transmitted as this information. The information may be obtained by power line communication using the charging cable, or by using a communication-dedicated line connected at the same time when the charging cable is connected.

Charging device 200 downloads required information from external server 300 in response to a request from the vehicle side. For example, charging device 200 and external server 300 are linked by a high-speed communication line, such as an ADSL (Asymmetric Digital Subscriber Line) line and an optical fiber line. Server 300 is arranged at a vehicle dealer 250, a repair shop and the like external to the home.

The communication is performed during charging, which results in an advantage that there is no possibility of a dead battery and the like in contrast to the data communication by a wireless device. Furthermore, the electric power of the battery is not consumed, and therefore, a distance that can be traveled in the EV traveling mode can be extended.

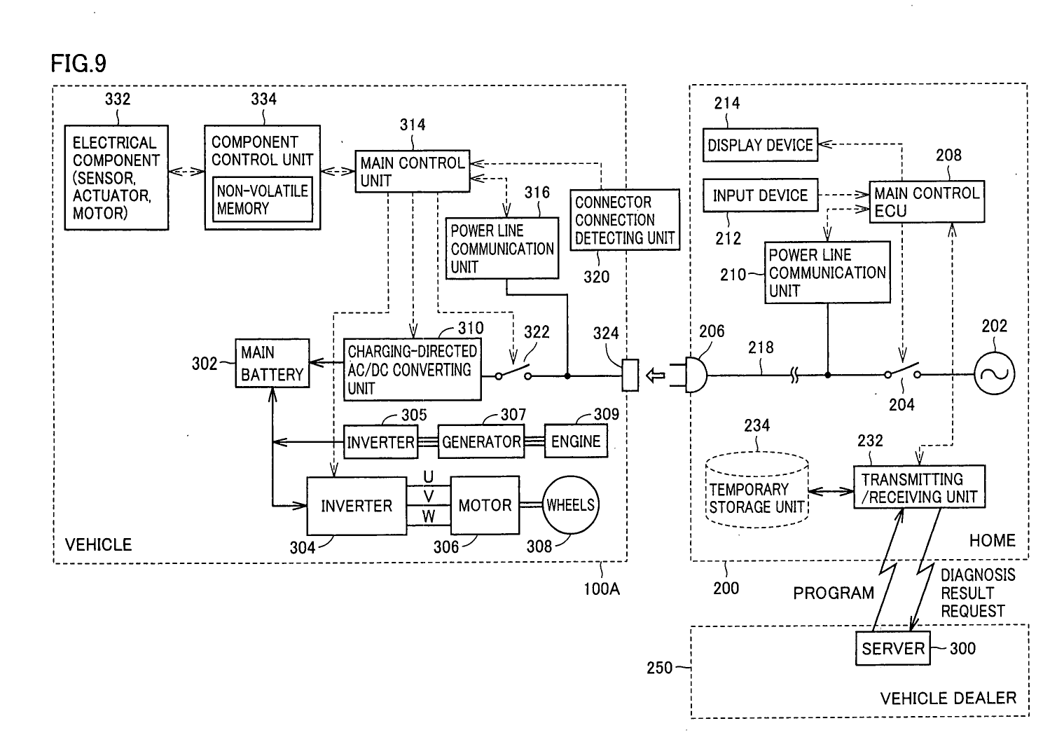

FIG. 9 is a block diagram showing a configuration of the vehicle and the charging device in more detail.

Referring to FIGS. 8 and 9, vehicle 100A includes wheels 308, a motor 306 driving wheels 308, an inverter 304 providing three-phase AC electric power to motor 306, and a main battery 302 supplying DC electric power to inverter 304.

Vehicle 100A further includes an engine 309, a generator 307 receiving a mechanical motive power from engine 309 and generating electric power, an inverter 305 converting a three-phase alternating current output from generator 307 to a direct current, and a main control unit 314 for controlling inverters 304 and 305. In other words, vehicle 100A is a hybrid vehicle that uses the motor and the engine for driving. The present invention, however, is also applicable to an electric vehicle and the like.

Vehicle 100A has a configuration in which main battery 302 can be charged from outside. In other words, vehicle 100A further includes a connector 324 equipped with a terminal through which a commercial power supply, such as AC 100V, for example, is provided from outside, a charging-directed AC/DC converting unit 310 converting AC electric power provided to connector 324 to DC electric power and providing the converted DC electric power to main battery 302, a switch 322 connecting connector 324 and charging-directed AC/DC converting unit 310, a connector connection detecting unit 320 for detecting that a charging plug 206 of charging device 200 is connected to connector 324, and a power line communication unit 316.

It is noted that switch 322 and connector 324 serve as the coupling unit for electrically coupling vehicle 100A to the external power supply device. By operating switch 322, the vehicle and the aforementioned external power supply are electrically coupled.

Main control unit 314 monitors state of charge SOC of main battery 302, and detects connection of the connector by connector connection detecting unit 320. If state of charge SOC is lower than the prescribed value when charging plug 206 is connected to connector 324, main control unit 314 shifts switch 322 from the opened state to the connected state and operates charging-directed AC/DC converting unit 310, and main battery 302 is charged.

Charging device 200 includes a power line communication unit 210 receiving, from the vehicle 100A side, information such as state of charge SOC and a request for electric power feeding, an AC power supply 202, a charging cable 218, a charging plug 206 provided at the end of charging cable 218, a switch 204 connecting AC power supply 202 to charging cable 218, and a main control ECU 208 for controlling opening and closing of switch 204.

In a case where connector connection detecting unit 320 confirms the connection and main battery 302 is charged, main control unit 314 requests charging device 200 through power line communication unit 316 to feed electric power. Alternatively, state of charge SOC may be conveyed from main control unit 314 through power line communication unit 316 to the charging device 200 side, and the start of the electric power feeding may be determined on the charging device 200 side, based on state of charge SOC.

In a case where the request for electric power feeding is made from the vehicle 100A side to the charging device 200 side, main control ECU 208 closes switch 204 to start electric power feeding. Main control unit 314 operates charging-directed AC/DC converting unit 310, and main battery 302 is charged.

After charging is completed, state of charge SOC of main battery 302 becomes greater than the prescribed value. In accordance therewith, main control unit 314 stops charging-directed AC/DC converting unit 310, and shifts switch 322 from the closed state to the opened state. Main control unit 314 requests charging device 200 through power line communication unit 316 to stop the electric power feeding. Then, main control ECU 208 shifts switch 204 from the closed state to the opened state.

Vehicle 100A further includes an electrical component 332 such as a sensor, an actuator and a motor, and a component control unit 334 receiving and transmitting a signal from/to electrical component 332. Component control unit 334 includes a non-volatile memory storing a result of failure diagnosis and a program.

Upon detecting that charging plug 206 is connected to connector 324, main control unit 314 of vehicle 100A imparts the result of the diagnosis and a version of the incorporated program through power line communication unit 316. Main control ECU 208 that has received information such as the result of the diagnosis and the version of the incorporated program through power line communication unit 210 causes transmitting/receiving unit 232 to communicate with server 300, and sends the result of the diagnosis and the version of the incorporated program.

In order that such a transmission can be performed, coupling unit 41 shown in FIG. 1 preferably includes connector 324 for electrically connecting external AC power supply 202 and vehicle 100A in a case of FIG. 9. Vehicle 100A includes the power line communication unit that operates as a transmitting unit transmitting information about failure diagnosis to the outside of the vehicle through cable 218 connected between connector 324 and external AC power supply 202.

Server 300 has the result of the diagnosis registered in a database of the vehicle. In a case where the version of the program is not the latest one, server 300 delivers a program of the latest version to transmitting/receiving unit 232. The delivered program is received by power line communication unit 316 through the cable, and is replaced with an internal program of main control unit 314 and a program stored in the non-volatile memory of component control unit 334.

In order that such a reception of the program and the like can be performed, coupling unit 41 shown in FIG. 1 preferably includes connector 324 for electrically connecting external AC power supply 202 and vehicle 100A in a case of FIG. 9. Vehicle 100A includes power line communication unit 316 that operates as a receiving unit receiving a control program of electrical component 332 from outside of the vehicle through cable 218 connected between connector 324 and external AC power supply 202.

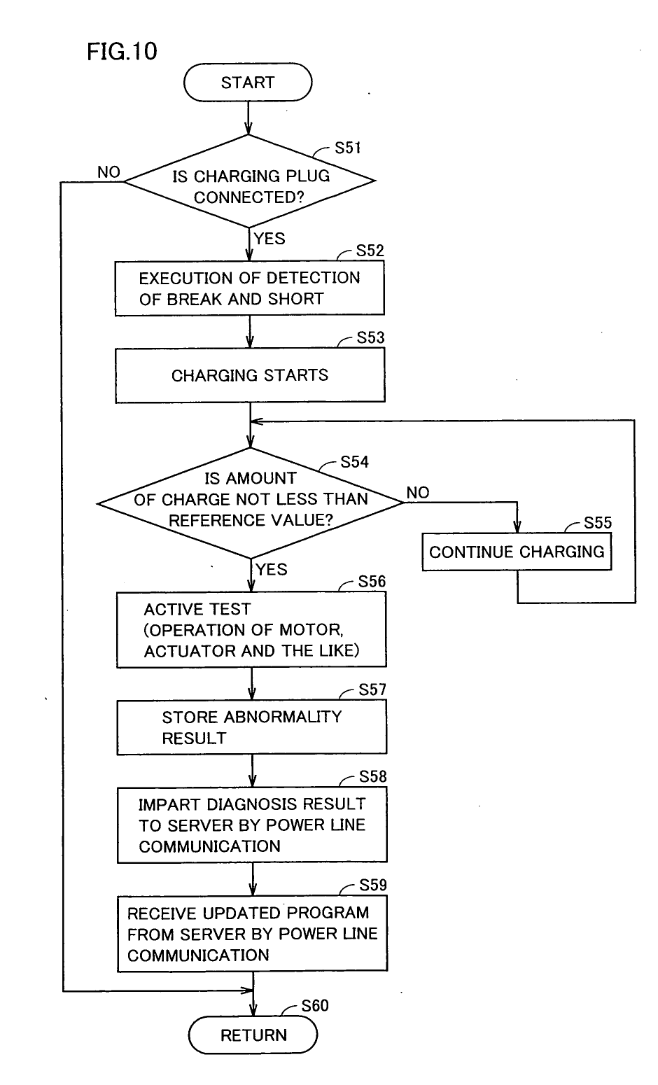

FIG. 10 is a flowchart for illustrating control relating to charging and failure diagnosis performed in vehicle 100A. The process in this flowchart is called for execution from a prescribed main routine at regular time intervals or whenever a prescribed condition is established.

Referring to FIGS. 9 and 10, initially, when the process starts, main control unit 314 determines whether or not charging plug 206 is connected to connector 324 in step S51. Main control unit 314 can detect whether or not charging plug 206 is connected, by an output of connector connection detecting unit 320 for physically detecting insertion of the plug.

If the connection of charging plug 206 is not detected in step S51, the process proceeds to step S60, and the control is moved to the main routine.

If the connection of charging plug 206 is detected in step S51, the process proceeds to step S52. In step S52, detection of a break and a short is performed, and it is initially confirmed whether or not normal charging is possible. Furthermore, in step S52, main control unit 314 checks whether or not a break and a short occur in the signal lines of the various types of sensors that are not directly related to charging.

If normal charging is possible, the following failure diagnosis is performed by using electric power supplied from external AC power supply 202 serving as a commercial power supply. Therefore, if the charging plug is inserted, discharge of main battery 302 does not basically proceed by failure diagnosis.

If main battery 302 is in a chargeable state after the basic failure diagnosis is terminated in step S52, the process proceeds to step S53, and charging starts. Switch 322 is set to a conduction state and charging-directed AC/DC converting unit 310 operates. Then, in step S54, it is determined whether or not the amount of charge of main battery 302 is not less than the reference value. There are various methods for determining priorities assigned to failure diagnosis and charging. In the third embodiment, battery B1 is initially charged such that the amount of charge (or state of charge SOC) thereof has a value not less than the reference value, and then, the active test whose electric power consumption is large is performed.

The active test performed in step S56 is a test in which it is necessary to operate the electrical component whose electric power consumption is relatively large, such as a motor and an actuator. Specifically, main control unit 314 issues a command to component control unit 334 to perform failure diagnosis. For example, in the active test, the motor of the electronic control throttle is operated, and it is tested whether or not a scheduled operation is detected by the throttle sensor. Other test in which the motor of the electric VVT mechanism, the electric water pump, the electric oil pump, the electric turbo charger, or the like is operated may be performed.

If a result of the active test for failure diagnosis is revealed in step S56, the process proceeds to step S57. In step S57, the diagnosis result in steps S52 and S56 that there is an abnormality is stored in an internal memory.

As described above, the control in steps S51 to S57 starting from “start” is basically the same as that in steps S11 to S17 described in FIG. 6, respectively.

The data stored in step S57 is read and used in order to determine a type of failure at a dealer or a repair shop. Therefore, in step S58, the data is transferred through power line communication unit 316, electric power cable 218 and power line communication unit 210 to main control ECU 208 by power line communication. Then, the data is transferred from main control ECU 208 through transmitting/receiving unit 232 such as a modem to server 300 at vehicle dealer 250. It is noted that a temporary storage unit 234 temporarily storing the result may be provided in charging device 200.

Next, in step S59, a current program of the vehicle ECU, a version of control parameter data and the like are further transferred to server 300. In a case where it is determined, based on the data of the result of failure diagnosis, the version of the program and the like, that the program of the vehicle ECU and the control parameter data should be updated, server 300 transmits a new program and control parameter data to transmitting/receiving unit 232 at home. In step S59, these program and control parameter data are transferred through main control ECU 208, power line communication unit 210, electric power cable 218, and power line communication unit 316 to main control unit 314, and required rewrite of a program and data in the memory is performed.

After the process in step S59 is terminated, the process proceeds to step S60, and the control is moved to the main routine.

In the third embodiment, failure diagnosis can be performed without reducing the state of charge of the battery, as in the first and second embodiments. Furthermore, in the third embodiment, the result of failure diagnosis is transferred to the server at home or at the dealer through the charging cable connected to the vehicle. Therefore, the result of failure diagnosis can be made use of in various services such as detailed analysis of the result of failure diagnosis and announcement of the need for repair.

It is noted that, in the above embodiments, the configuration has been mainly described in which failure diagnosis is performed by the active test for the components related to the engine whose rate of operation may be lowered in a case of the hybrid vehicle. The technique disclosed in the present embodiments is also applicable, however, to a configuration in which an electric brake, an inverter, a motor generator, an electric suspension, an electric differential gear, or the like, not the components related to the engine, is operated during charging and failure diagnosis is performed.

Furthermore, the control method disclosed in the above embodiments can be executed by software by using a computer. A program for causing the computer to execute this control method may be read into the computer in the controller of the vehicle from a storage medium (ROM, CD-ROM, memory card, and the like) storing the program in a computer readable manner, or may be provided through a communication line.

Furthermore, as to charging from outside, the configuration in which the connector is physically inserted into the vehicle for charging has been described as an example. Charging, however, may be performed in a non-contact manner by electromagnetic induction, a microwave and the like.

In addition, in the present embodiments, an example has been described in which the present invention is applied to a series/parallel-type hybrid system in which the power split device can split motive power of the engine so that the split power is transmitted to an axle and a generator. The present invention, however, is also applicable to a series-type hybrid vehicle using the engine only for driving the generator and generating driving force of the axle only by the motor that uses the electric power generated by the generator, or an electric vehicle that travels by using only the motor.

It should be understood that the embodiments disclosed herein are illustrative and not limitative in any respect. The scope of the present invention is defined by the terms of the claims, rather than the description above, and is intended to include any modifications within the scope and meaning equivalent to the terms of the claims.

1. A vehicle, comprising:
a power storage device;
a motor driven by electric power stored in said power storage device;
a coupling unit for electrically coupling said power storage device to an external power supply; and
a control unit for operating an electrical component and performing failure diagnosis of said electrical component in a case where the vehicle and said external power supply can be electrically coupled by operating said coupling unit.

2. The vehicle according to claim 1, wherein
when said power storage device is being charged by using electric power supplied from outside through said coupling unit, said control unit performs said failure diagnosis in parallel with charging by using the electric power supplied from outside through said coupling unit or the electric power charged in said power storage device.

3. The vehicle according to claim 1, wherein
said coupling unit includes a connector for electrically connecting said external power supply and said vehicle, and
said vehicle further includes a transmitting unit for transmitting information about said failure diagnosis to the outside of the vehicle through a cable connected between said connector and said external power supply.

4. The vehicle according to claim 1, wherein
said coupling unit includes a connector for electrically connecting said external power supply and said vehicle, and
said vehicle further includes a receiving unit for receiving a control program of said electrical component from outside of the vehicle through a cable connected between said connector and said external power supply.

5. The vehicle according to claim 1, further comprising:
an internal combustion engine, wherein
said electrical component is a component related to at least one of intake and discharge of air in said internal combustion engine.

6. A vehicle, comprising:
a power storage device;
a motor driven by electric power stored in said power storage device;
a coupling unit for electrically coupling said power storage device to an external power supply; and
a control unit for operating an electrical component by using electric power supplied from at least any one of said power storage device and said external power supply, and performing failure diagnosis of said electrical component, in a state where said coupling unit and said external power supply are physically connected.

7. The vehicle according to claim 6, wherein
said control unit performs failure diagnosis of said electrical component when a charging cost in a case where said power storage device is charged by said external power supply is lower than a reference value.

8. The vehicle according to claim 6, wherein
said control unit determines a state of charge of said power storage device, and upon determining that said state of charge is not less than a prescribed value, said control unit performs failure diagnosis of said electrical component.

9. The vehicle according to claim 8, wherein
said control unit performs failure diagnosis of said electrical component when a charging cost in a case where said power storage device is charged by said external power supply is lower than a reference value.

10. The vehicle according to claim 6, wherein
said coupling unit includes a connector for electrically connecting said external power supply and said vehicle, and
said vehicle further includes a transmitting unit for transmitting information about said failure diagnosis to the outside of the vehicle through a cable connected between said connector and said external power supply.

11. The vehicle according to claim 6, wherein
said coupling unit includes a connector for electrically connecting said external power supply and said vehicle, and
said vehicle further includes a receiving unit for receiving a control program of said electrical component from outside of the vehicle through a cable connected between said connector and said external power supply.

12. The vehicle according to claim 6, further comprising:
an internal combustion engine, wherein
said electrical component is a component related to at least one of intake and discharge of air in said internal combustion engine.

13. A method for failure diagnosis of a vehicle having a power storage device, a motor driven by electric power stored in said power storage device, and a coupling unit for electrically coupling said power storage device and an external power supply, comprising the steps of:
determining that the vehicle and said external power supply can be electrically coupled by operating said coupling unit; and
operating an electrical component and performing failure diagnosis of said electrical component in a case where the vehicle and said external power supply can be electrically coupled.

14. The method for failure diagnosis of a vehicle according to claim 13, further comprising the step of:
charging said power storage device by using electric power supplied from outside through said coupling unit, wherein
in said step of performing failure diagnosis, said failure diagnosis is performed in parallel with charging by using the electric power supplied from outside through said coupling unit or the electric power charged in said power storage device.
